(19) United States
(12) Patent Application Publication
(10) Pub. No.: US 2008/0114961 A1
(43) Pub. Date: May 15, 2008

(54) Transparent device switchover in a storage area network

(75) Inventors: Badrinarayanan Ramaswamy, Saratoga, CA (US); Harsha Bharadwaj, D.C.Halli (IN); Joy Chatterjee, Kundalahalli (IN); Richard Harper, Apex, NC (US); Rajeev Bhardwaj, Sunnyvale, CA (US)

Correspondence Address: BEYER WEAVER LLP, P.O. BOX 70250, OAKLAND, CA, 94612-0250, US

(73) Assignee: Cisco Technology, Inc., San Jose, CA (US)

(21) Appl. No.: 11/600,486

(22) Filed: Nov. 15, 2006

(51) Int. Cl. G06F 12/00

(52) U.S. Cl. 711/170; 711/E12.001

(57) ABSTRACT

Initiators and targets in a storage area network are presented as virtualized devices by a virtualization engine. An initiator accesses a virtualized target as though it was accessing a physical target. A target accesses a virtualized initiator as though it was accessing a physical initiator. A virtualization engine performs port World Wide Name (WWN) and FCID mapping to allow continued access to virtual initiators and virtual targets even if a particular physical initiator or physical target fails and the secondary is made active.

### BACKGROUND OF THE INVENTION

1. Field of the Invention

The present invention generally relates to storage area networking. More specifically, the present invention provides techniques and mechanisms for improved device migration in a storage area network.

2. Description of Related Art

A storage area network includes a number of entities including hosts, fibre channel switches, disk arrays, tape devices, etc. High availability is often an important consideration in storage area network implementation. Some limited high availability mechanisms are available for fibre channel switches and end devices. For example, a fibre channel switch may include both an active and a standby supervisor. If an active supervisor fails, a standby supervisor assumes operation.

Some limited high availability mechanisms are also available for devices such as disk arrays. A disk array including multiple disks may provide replication for data stored on a particular disk. If the particular disk fails, mirrored data stored on the failed disk can be accessed using a backup disk. However, many possible points of failure may render a storage area network unusable for an extensive period of time. Furthermore, many conventional high availability mechanisms require extensive down time or reconfiguration of a storage area network.

Current mechanisms for providing high availability in storage area networks have significant limitations. Consequently, it is desirable to provide techniques for improving device migration and other failover mechanisms in storage area networks.

### SUMMARY OF THE INVENTION

Initiators and targets in a storage area network are presented as virtualized devices by a virtualization engine. An initiator accesses a virtualized target as though it was accessing a physical target. A target accesses a virtualized initiator as though it was accessing a physical initiator. A virtualization engine performs port World Wide Name (WWN) and FC_ID mapping of the frames to allow continued access to virtual initiators and virtual targets even if a particular physical initiator or physical target fails and the secondary is made active.

In one embodiment, a method for processing an I/O request in a storage area network is provided. A virtualization engine associated with a storage area network switch receives a first I/O request from a physical initiator. The I/O request includes a virtual target identifier. The virtual target identifier included in the I/O request is mapped to a physical target. The I/O request from the virtualization engine associated with the storage area network switch is forwarded to the physical target.

In another embodiment, a storage area network device is provided. The storage area network device includes an input interface, a processor, and an output interface. The input interface is operable to receive a first I/O request including a virtual target identifier from a physical initiator. The processor is operable to map the virtual target identifier included in the I/O request to a physical target. The output interface is operable to forward the I/O request to the physical target.

A further understanding of the nature and advantages of the present invention may be realized by reference to the remaining portions of the specification and the drawings.

### BRIEF DESCRIPTION OF THE DRAWINGS

The invention may best be understood by reference to the following description taken in conjunction with the accompanying drawings, which are illustrative of specific embodiments of the present invention.

FIG. 1 is a diagrammatic representation showing initiators accessing a disk array.

FIG. 2 is a diagrammatic representation showing initiators accessing a disk array using a virtual target.

FIG. 3 is a diagrammatic representation showing a target responding to an initiator using a virtual initiator.

FIG. 4 is a graphical representation showing virtual target zoning.

FIG. 5 is a flow process diagram showing one technique for accessing a virtual target.

FIG. 6 is a flow process diagram showing one technique for continuing to access a virtual target.

FIG. 7 is a diagrammatic representation showing a network device.

### DETAILED DESCRIPTION OF SPECIFIC EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fibre channel storage area networks. However, it should be noted that the techniques of the present invention can be applied to different variations and flavors of fibre channel storage area networks as well as to alternatives to fibre channel storage area networks. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Furthermore, techniques and mechanisms of the present invention will sometimes be described in singular form for clarity. However, it should be noted that some embodiments can include multiple iterations of a technique or multiple instantiations of a mechanism unless noted otherwise. For example, a processor is used in a variety of contexts. However, it will be appreciated that multiple processors can also be used while remaining within the scope of the present invention.

Conventional storage area networks are implemented with the goal of providing high availability. Storage area networks typically include devices such as disk arrays, tape devices, and hosts. The devices are often connected using multiple fibre channel switches. In some instances, a storage area network may include tunneling switches that allow communication between two subnets over an Internet Protocol (IP) network. The devices that initiate requests such as read or write requests for data are referred to herein as initiators. Initiators include hosts and servers. The devices that respond to requests such as read and write requests for data are referred to herein as targets. Targets include Redundant Arrays of Independent Disks (RAIDs) and tape drives.

To provide high availability, target devices such as storage disk arrays should be made available for I/O requests with minimal downtime. In order to handle potential disk failures, data is often replicated using mechanisms such as mirroring to ensure that a standby target device can take over should an active target device fail.

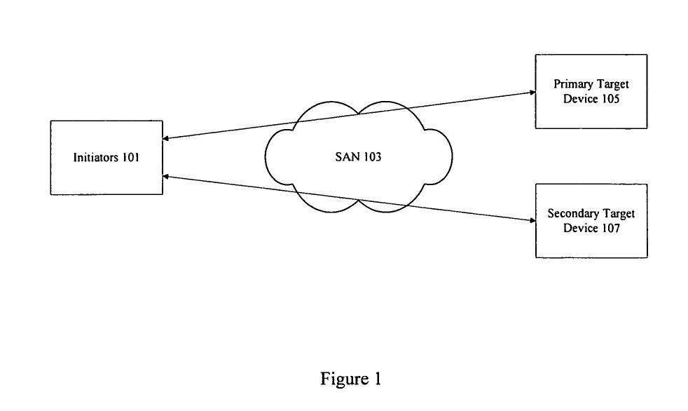

FIG. 1 is a diagrammatic representation showing initiators accessing a disk array. Multiple initiators 101 are connected to a storage area network 103. Primary disk array 105 and secondary disk array 107 are also connected to the storage area network 103. The primary disk array 105 and the secondary disk array 107 can also be referred to herein as the active disk array 105 and the standby disk array 107. Multiple initiators 101 may include a number of different servers connected to different fibre channel switches in the SAN 103. According to various embodiments, all of the initiators 101 are configured to access a primary disk array 105 through the SAN 103 by using a port world wide name (pWWN) associated with the disk array 105. However, a variety of circumstances may necessitate a switch to secondary disk array 107. For example, a disk array 105 may experience hardware failures or data corruption. There may be data migration issues, such as technology refresh, workload balancing and storage consolidation.

The failover from the primary to the secondary target involves substantial downtime and requires manual intervention by the SAN administrator. The administrator is expected to perform zoning changes and reconfiguration of particular initiators. In some examples, all the initiators now have to be rezoned to the secondary target and the zone set has to be reactivated in the fabric. Sometimes the full zone sets are not synchronized with active zone sets and hence the secondary target configuration has to be redone by the administrator. Initiators such as particular servers also have to be reconfigured because the secondary target pWWN and fibre channel identifier (FC_ID) are different from the primary target pWWN and FC_ID. Some of these servers have the target FC_ID encoded in system configuration files necessitating server reboots to allow an update to the FC_ID.

Rezoning and reconfiguration require a substantial amount of time. Zoning configuration can be disruptive to fabric operation. The reconfiguration of the initiator driver files is error prone.

In order to reduce the downtime and the risks associated with device migration such as target or initiator failover, various embodiments of the present invention allow virtualization of targets and initiators at a fibre channel storage area network switch. In some examples, initiators are presented with a virtual target and targets are presented with a virtual initiator. If a particular initiator or target fails, mapping mechanisms are updated at a fibre channel switch to allow transparent device switchover. Initiators and targets no longer need to be restarted.

By providing virtualized targets and initiators, the amount of time required for migrating between targets and initiators is reduced. According to various embodiments, minimal configuration changes are required for fabric switches and no configuration changes are required for targets and initiators. Targets and initiators continue to access a virtualized device without any knowledge of migration of physical devices. Existing zoning configurations are used for grouping of initiators and virtual targets. In some examples, a single command is used to perform failover. The failover operation involves the virtual target going offline and then coming back online with the same FCID. This flap of the virtual target will be reported to initiators so that pending I/O requests are aborted and I/O requests are restarted.

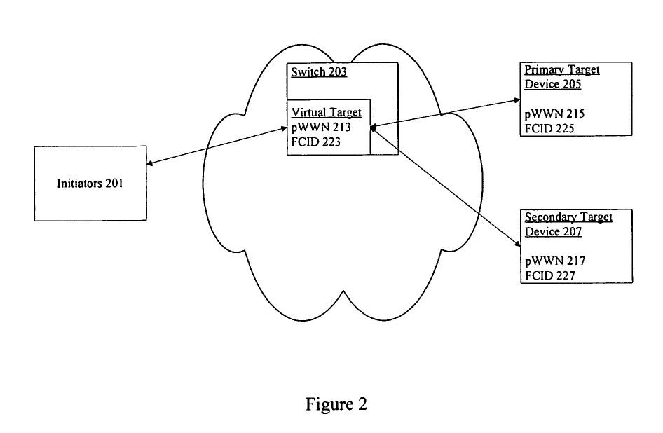

FIG. 2 is a diagrammatic representation showing an initiator accessing physical targets through a virtual target. An initiator 201 accesses a primary disk array 205. The primary disk array has a pWWN 215 and an FCID 225. A switch 203 connects the initiator 201 to the primary disk array 205. According to various embodiments, the switch 203 is a virtualization engine in a fibre channel storage area network. Instead of presenting a physical pWWN 215 and a physical FCID 225 to the initiator 201, the switch 203 presents a virtual target represented by pWWN 213 and FCID 223 to the initiator 201. The initiator 201 then uses the pWWN 213 and the FCID 223 for I/O requests. The switch 203 maintains a mapping of pWWN 213 to pWWN 215 and a mapping of FCID 223 to FCID 225. When the primary disk array 205 fails and secondary disk array takes over, the switch 203 updates mapping tables.

According to various embodiments, pWWN 213 is now mapped to pWWN 217 associated with secondary disk array 207 after failover. FCID 223 is now mapped to pWWN 227 associated with secondary disk array 207 after failover. It should be noted that more than one secondary device may be used. No reconfiguration of initiator 201 is required. In many implementations, the initiator 201 may have no knowledge that anything has changed on the target side.

In order for the virtual target to present itself as a physical target to the initiator 201, the virtual target is zoned with the initiator by user configuration. According to various embodiments, a zoning table indicates which initiator can access which target. In many examples, a zoning table shows pairs of initiators and targets that are authorized to exchange data. The virtual target including pWWN 213 and FCID 223 are also registered with a name server database and propagated to other switches in the storage area network. The status of the virtual target can be identical to the physical target to which it is linked. The virtual target has to register only if the physical target is online and deregister when the physical target goes offline.

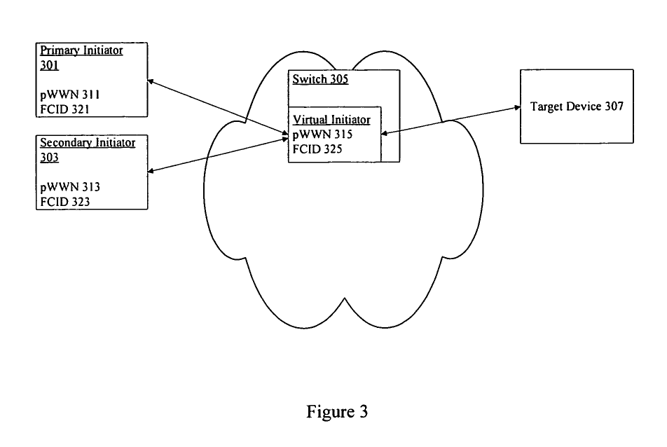

FIG. 3 is a diagrammatic representation showing a primary initiator accessing a target using a virtual initiator. A secondary initiator is also present that can take over the role of the primary if it fails. A target 307 is connected to switch 305. Switch 305 is also connected to initiator 301 and initiator 303. The initiator 301 has pWWN 311 and FCID 321. The switch 305 maps the virtual initiator with pWWN 315 and FCID 325 to pWWN 311 and FCID 321 associated with the initiator 301. Upon failover to the standby initiator, the switch 305 updates its mapping table and maps the virtual initiator with pWWN 315 and FCID 325 to pWWN 313 and FCID 323 associated with the initiator 303. According to various embodiments, the target 307 continues to operate without knowledge that the identity of the initiator has changed. It should be noted that in some embodiments, an initiator and a target are connected to different switches and different virtualization engines. Multiple virtualization engines may also be present in a fabric.

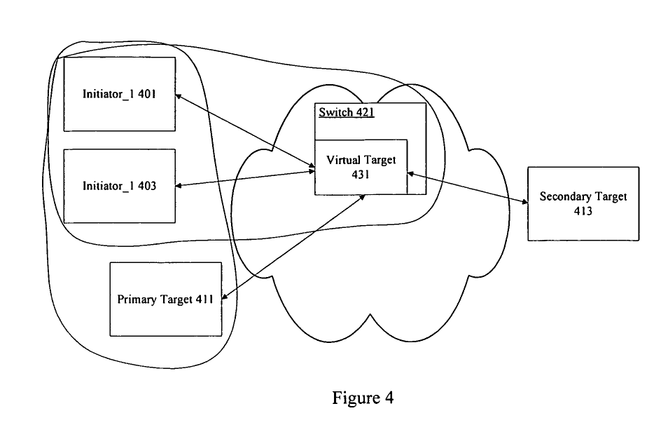

FIG. 4 is a diagrammatic representation showing zoning. According to various embodiments, an initiator can communicate with a virtual target after an {initiator, virtual target} pair is added to a zoning table. In some embodiments, the real target is not part of any zone in this scheme. As a result, the real target when it queries the name server can not see the initiators accessing it and any frames originating from the real target will be dropped at the ingress port due to hard-zoning. To get around this limitation, the concept of a “logical” zone is used that would include the primary target zoned with the initiators. The logical zone is not present physically in the active zone set or active zone table.

FIG. 4 shows a logical zone including primary target 411, initiator 401, and initiator 403. A user configured zone includes virtual target 431, initiator 401, and initiator 403. It may be noted that this logical zone is known only to the virtualization engine. According to various embodiments, the logical zone only alters the behavior of the name server and the registered state change notification (RSCN) to suit the requirements of a virtualization engine. Since all name server and RSCN network queries are zoned, the name server will query a zone server before replying to each query and RSCN will query the zone server before sending a RSCN for a device to other zone members. Any mechanism providing zoning information in a fibre channel storage area network is referred to herein as a zone server. According to various embodiments, the zone server behavior on receiving a name server/RSCN request is altered in several ways. In some examples, when a name server provides a real target and requests the zone server to provide other zone members, it returns all the initiators zoned with the virtual target 431. When the RSCN provides an initiator zoned with a virtual target 431 and requests that the zone server provide other zone members, it returns the primary physical target 411.

In one example, there is an {initiator 401, initiator 403, virtual target 431} zone and target 411 is defined as the primary target of virtual target 431. Initiator 401, initiator 403, virtual target 431 and target 411 are all online. If initiator 401 and initiator 403 perform a name server lookup, name server sends a request to the zone server for the other zone members. Zone server returns virtual target 431 according to the zoning configuration. Hence initiator 401 and/or initiator 403 can see virtual target 431. If target 411 performs a name server lookup, name server sends a request for other zone members. The zone server recognizes the presence of an logical zone and will then return initiator 401 and initiator 403. Hence target 411 should be able to see initiator 401 and initiator 403.

If initiator 401 and/or initiator 403 go online/offline, RSCN will send a request to the zone server for other zone members. The zone server then returns primary physical target 411, so that this RSCN is sent to target 411. If target 411 goes online/offline, the RSCN should not be generated. The zone server should return an empty member list. It may be noted that in this case initiator 401 and initiator 403 will come to know of this event since virtual target 431 behaves according to target 411 and an RSCN will be sent to them for virtual target 431. When RSCN queries the zone server for other members of virtual target 431, the zone server will return initiator 401 and initiator 403.

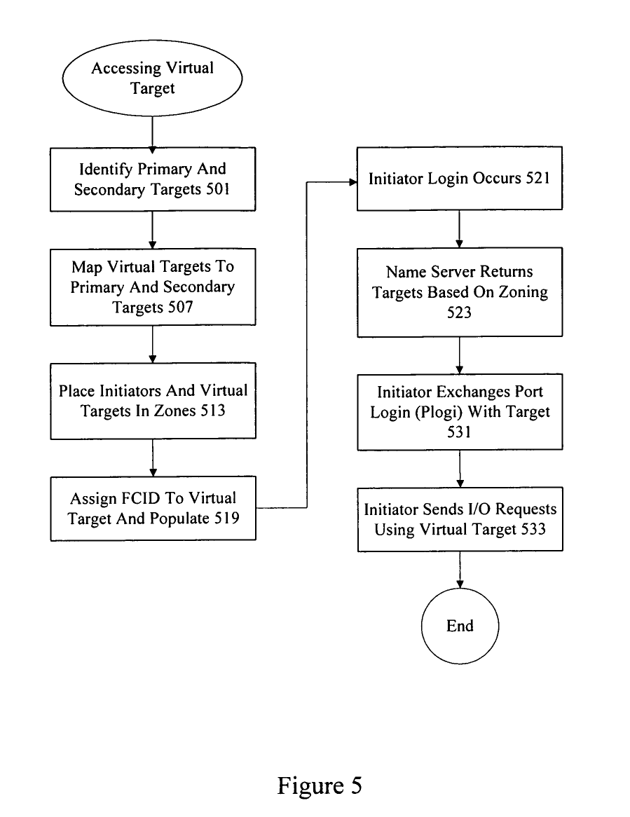

FIG. 5 is a flow process diagram showing one technique for accessing a virtual target. At 501, an administrator can identify primary and secondary targets 501. According to various embodiments, the administrator determines what resources are active and what resources are held in a standby state. At 507, virtual targets are mapped to primary and secondary targets.

At 513, initiators and virtual targets are placed in zones. The virtual target is used so that an initiator can communicate with a virtual target without having knowledge as to whether the virtual target is mapped to a primary target or a secondary target. At 519, an FCID is assigned to the virtual target and storage area network devices are populated with this information. According to various embodiments, the virtual target is online when the primary target is online. In some embodiments, a virtualization engine performs a registration with the name server for a virtual target only when the corresponding real target is online. If the real target goes offline, deregistration is performed for the virtual target.

At 521, initiator login occurs. According to various embodiments, the name server returns the virtual target based on zoning information tables. In some embodiments, rewrite entries to perform the translations are programmed in hardware at this point. According to various embodiments, certain ELS frames and ACC frames having an FCID and pWWN in the payload at various offsets are translated by forwarding the frames to the supervisor since payload rewrite is not possible in hardware. The FCIDs and WWNs in the payload are translated the same way the FCID in the header is translated. Load on the supervisor due to these frames is expected to be low. The frames are then transmitted to their destination.

At 531, the initiator performs a port login (Plogi) with the target using the virtual target FCID. This Plogi is captured by the supervisor, translated and sent to the real target. At 533, the initiator can then perform input/output (I/O) such as reads and writes to the primary target using the virtual target. These I/O frames are translated directly by the hardware at the ingress port and redirected to the primary target.

Typically most high-availability storage design is configured such that an entire storage array can be acting as the secondary for another storage array, with disk #1 on the secondary being the backup for disk #1 on the primary and so on. In such a scenario it may be required that if the primary array fails the entire set of disks have to do a failover which involves failover for each of the target pWWNs in the disk array. This operation would involve a “group” of failovers. Since this “group” failover involves executing multiple linking configuration operation for each disk pWWN, it is not only time consuming but also error prone. As a solution to this problem the concept of a Target Group is introduced.

A Target Group (TG) is a set of N target pWWNs that are logically grouped into a unit. This target group can then be used in all the virtual target configurations, as a representative of its member pWWNs. The TG is identified by an alphanumeric name and each of its pWWNs has a position index associated with it. The position index pairs its counterpart pWWN in another TG. After defining a TG and defining its members, it needs to be added to a virtual target. A failover between TGs in a virtual target is possible only if the secondary TG has the same N number of targets as the primary TG and the position indices list are identical i.e. for each pWWN P1 with position index X in TG1 there exists a pWWN P2 with the same position index X in TG2.

While TG configuration would be the desirable, it is also required to keep the granularity of being able to failover just one target pWWN in the group, if only one of the disks in an array were to fail. This can be achieved by linking a Target group which is a duplicate of the existing group but with the primary disk pWWN replaced by secondary disk pWWN. It may be noted that a virtual target can be defined to either have all TGs OR all target-pWWNs, since a failover from a TG to a target-pWWN OR vice-versa should not be allowed. A virtual target defined with TGs would enumerate to a set of virtual targets the number of targets in the group, with each target in the group having a corresponding virtual target.

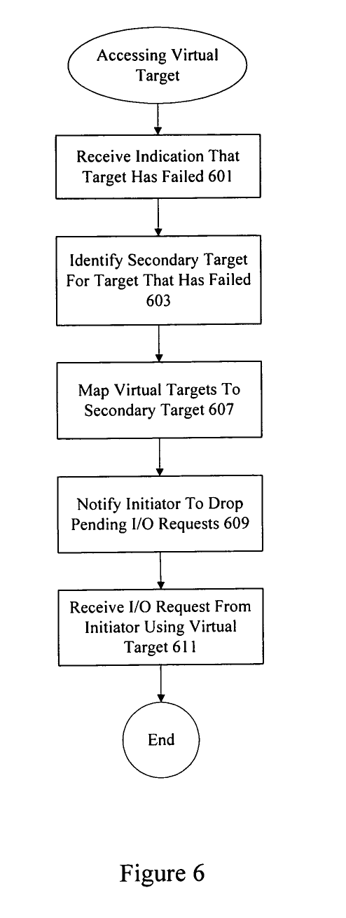

FIG. 6 is a flow process diagram showing a technique for continuing to access a virtual target. At 601, a virtualization engine receives an indication that a target has failed.

Notification of failure of a target can come in the form of an RSCN message. At 603, the virtualization engine identifies a backup target device for the target that has failed. This can be performed manually or automatically. The virtual target goes down and comes back up. At 607, the virtual target is now mapped to the backup target instead of to the failed active target. At 609, the initiator drops pending I/O requests due to the RSCN sent for the virtual target going down. At 611, I/O requests are received from the initiator using virtual target information.

The techniques of the present invention can be implemented in a variety of devices such as routers and switches. In some examples, the reverse path delay estimation techniques can be implemented on any network device. In other examples, the techniques of the present invention can also be implemented at tunneling switches used to transmit storage application data over IP networks. Although a particular example using multiple targets has been described, it should be noted that the techniques of the present invention can also be used to provide initiator access through virtual initiators.

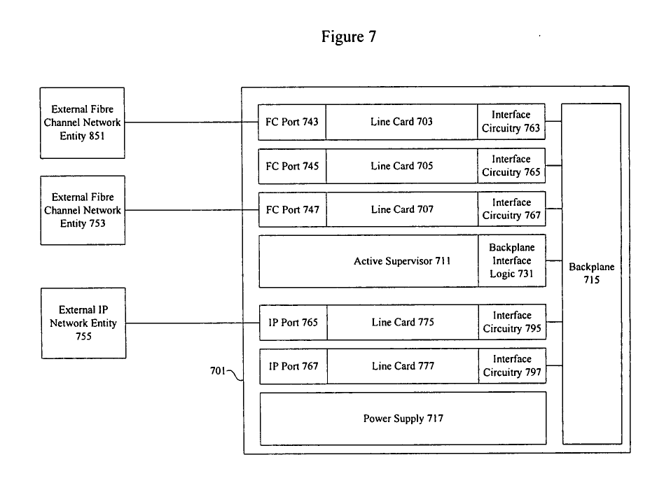

FIG. 7 is a diagrammatic representation of one example of a fibre channel switch that can be used to implement techniques of the present invention. Although one particular configuration will be described, it should be noted that a wide variety of switch and router configurations are available. The tunneling switch 701 may include one or more supervisors 711. According to various embodiments, the supervisor 711 has its own processor, memory, and storage resources.

Line cards 703, 705, and 707 can communicate with an active supervisor 711 through interface circuitry 783, 785, and 787 and the backplane 715. According to various embodiments, each line card includes a plurality of ports that can act as either input ports or output ports for communication with external fibre channel network entities 751 and 753. The backplane 715 can provide a communications channel for all traffic between line cards and supervisors. Individual line cards 703 and 707 can also be coupled to external fibre channel network entities 751 and 753 through fibre channel ports 743 and 747.

External fibre channel network entities 751 and 753 can be nodes such as other fibre channel switches, disks, RAIDS, tape libraries, or servers. It should be noted that the switch can support any number of line cards and supervisors. In the embodiment shown, only a single supervisor is connected to the backplane 715 and the single supervisor communicates with many different line cards. The active supervisor 711 may be configured or designed to run a plurality of applications such as routing, domain manager, system manager, and utility applications.

According to one embodiment, a routing application is configured to populate hardware forwarding tables used to direct frames towards their intended destination by choosing the appropriate output port and next hop. A utility application can be configured to track the number of buffers and the number of credits used. A domain manager application can be used to assign domains in the fibre channel storage area network. Various supervisor applications may also be configured to provide functionality such as flow control, credit management, and quality of service (QoS) functionality for various fibre channel protocol layers.

According to various embodiments, the switch also includes line cards 775 and 777 with IP interfaces 765 and 767. In one example, the IP port 765 is coupled to an external IP network entity 755. The line cards 775 and 777 can also be coupled to the backplane 715 through interface circuitry 795 and 797.

According to various embodiments, the switch can have a single IP port and a single fibre channel port. In one embodiment, two fibre channel switches used to form an FCIP tunnel each have one fibre channel line card and one IP line card. Each fibre channel line card connects to an external fibre channel network entity and each IP line card connects to a shared IP network.

In addition, although an exemplary switch is described, the above-described embodiments may be implemented in a variety of network devices (e.g., servers) as well as in a variety of mediums. For instance, instructions and data for implementing the above-described invention may be stored on a disk drive, a hard drive, a floppy disk, a server computer, or a remotely networked computer. Accordingly, the present embodiments are to be considered as illustrative and not restrictive, and the invention is not to be limited to the details given herein, but may be modified within the scope and equivalents of the appended claims.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of network protocols and architectures. It is therefore intended that the invention be interpreted to include all variations and equivalents that fall within the true spirit and scope of the present invention.

What is claimed is:

1. A method for processing an I/O request in a storage area network, the method comprising:
receiving a first I/O request from a first physical initiator, the first I/O request received at a virtualization engine associated with a storage area network switch, wherein the first I/O request includes a virtual target identifier;
mapping the virtual target identifier included in the I/O request to a first physical target;
forwarding the I/O request from the virtualization engine associated with the storage area network switch to the first physical target.

2. The method of claim 1, further comprising:
receiving an indication that the first physical target is no longer available.
updating a mapping mechanism to map the virtual target identifier to a second physical target.

3. The method of claim 2, further comprising:
receiving a second I/O request from the first physical initiator, the second I/O request received at the virtualization engine, wherein the second I/O request includes the virtual target identifier;
mapping the virtual target identifier included in the I/O request to the second physical target;
forwarding the I/O request from the virtualization engine associated with the storage area network switch to the second physical target.

4. The method of claim 1, further comprising:
receiving a first I/O response from the first physical target, the first I/O response received at the virtualization engine associated with the storage area network switch, wherein the first I/O response includes a virtual initiator identifier;
mapping the virtual initiator identifier included in the I/O response to the first physical initiator;
forwarding the I/O response from the virtualization engine associated with the storage area network switch to the first physical initiator.

5. The method of claim 1, further comprising:
receiving an indication that the first physical initiator is no longer available.
updating a mapping mechanism to map the virtual initiator identifier to a second physical initiator.

6. The method of claim 5, further comprising:
receiving a second I/O response from the first physical target, the second I/O response received at the virtualization engine, wherein the second I/O response includes the virtual initiator identifier;
mapping the virtual initiator identifier included in the I/O response to the second physical initiator;
forwarding the I/O response from the virtualization engine associated with the storage area network switch to the second physical initiator.

7. The method of claim 1, wherein the mapping mechanism is a zoning table.

8. The method of claim 1, wherein the first physical target is a disk array.

9. The method of claim 1, wherein the second physical target is a standby disk array mirroring the first physical target.

10. The method of claim 1, wherein the first physical initiator is a host.

11. The method of claim 1, wherein unavailability of the first physical target is not detected by the first physical initiator.

12. The method of claim 1, wherein unavailability the first physical initiator is not detected by the first physical target.

13. A storage area network device, comprising:
an input interface operable to receive a first I/O request from a first physical initiator, wherein the first I/O request includes a virtual target identifier;
a processor operable to map the virtual target identifier included in the I/O request to a first physical target;
an output interface operable to forward the I/O request to the first physical target.

14. The storage area network device of claim 13, wherein the input interface is further operable to receive an indication that the first physical target is no longer available and the processor is further operable to update a mapping mechanism to map the virtual target identifier to a second physical target.

15. The storage area network device of claim 14, wherein the input interface is further operable to receive a second I/O request from the first physical initiator and the processor is further operable to map the virtual target identifier included in the I/O request to the second physical target.

16. The storage area network device of claim 15, wherein the output interface is further operable to forward the I/O request to the second physical target.

17. The method of claim 13, wherein the mapping mechanism is a zoning table.

18. The method of claim 13, wherein the first physical target is a disk array.

19. The method of claim 13, wherein the second physical target is a standby disk array mirroring the first physical target.

20. A system for processing an I/O request in a storage area network, the system comprising:
means for receiving a first I/O request from a first physical initiator, wherein the first I/O request includes a virtual target identifier;
means for mapping the virtual target identifier included in the I/O request to a first physical target;
means for forwarding the I/O request from the virtualization engine associated with the storage area network switch to the first physical target.

21. A computer readable medium, comprising:
computer code for receiving a first I/O request from a first physical initiator, the first I/O request received at a virtualization engine associated with a storage area network switch, wherein the first I/O request includes a virtual target identifier;
computer code for mapping the virtual target identifier included in the I/O request to a first physical target;
computer code for forwarding the I/O request from the virtualization engine associated with the storage area network switch to the first physical target.

22. A virtual target device, comprising:
an input interface operable to receive a first I/O request from a first physical initiator, wherein the first I/O request includes a virtual target identifier associated with the virtual target device;
a processor operable to map the virtual target identifier included in the I/O request to a first physical target;
an output interface operable to forward the I/O request to the first physical target.

23. The virtual target device of claim 22, wherein the virtual target device is associated with a port World Wide Name (pWWN) and a fibre channel identifier (FCID)
